(19) United States
(12) Patent Application Publication
(10) Pub. No.: US 2025/0307234 A1
(43) Pub. Date: Oct. 2, 2025

(54) CONSISTENT AND DURABLE TRANSACTIONS IN A HIGH-PERFORMANCE DISTRIBUTED STORAGE SYSTEM

(71) Applicant: NUTANIX, INC., San Jose, CA (US)

(72) Inventors: Rohit JAIN, Cupertino, CA (US); Tabrez Parvez MEMON, Campbell, CA (US); Harshit AGARWAL, Fremont, CA (US); Ashwin THENNARAMVAKKAYIL, Bengaluru (IN)

(21) Appl. No.: 19/082,076

(22) Filed: Mar. 17, 2025

(30) Foreign Application Priority Data
Apr. 1, 2024 (IN) 202441027045

(51) Int. Cl. G06F 16/23; G06F 11/14; G06F 16/27

(52) U.S. Cl. CPC G06F 16/2379; G06F 11/1469; G06F 16/273; G06F 2201/84

(57) ABSTRACT

Techniques for storing data in a cluster include receiving, at a first node, a write transaction directed to a first data block of a first extent in an extent group and logging, at the first node, a tentative update in a tentative update journal for a first replica of the first data block. The techniques further include subsequent to logging the tentative update, forwarding the write transaction to a second node, determining that the first node restarted before the write transaction was committed on the first node, and rolling back the write transaction for the first replica.

### CROSS-REFERENCE TO RELATED APPLICATIONS

This application claims priority to India Provisional Application No. 20/244,1027045, titled “CONSISTENT AND DURABLE TRANSATIONS IN A HIGH-PERFORMANCE DISTRIBUTED STORAGE SYSTEM,” filed on Apr. 1, 2024, the subject matter of which is incorporated by reference herein.

### BACKGROUND

### Field of the Various Embodiments

Embodiments of the present invention relate generally to database management technologies, and more specifically, to consistent and durable transactions in a high-performance distributed storage system.

### Description of the Related Art

In networked storage systems, it is common to store data in a set of blocks distributed across multiple disk drives, where those disk drives reside on multiple nodes in the networked storage system. Such a set of blocks distributed across multiple disk drives is referred to herein as an extent group or an egroup. The node that receives a write operation is designated as the leader that is responsible for managing the data transactions for the networked storage related to that write operation. A primary goal of a networked storage systems deployed to execute mission critical workloads is to provide data consistency and durability to user applications and protect the application data, including preservation of consistent data after a disk or node failure. Another important goal is to provide the highest possible performance and thereby leverage the capabilities of the underlying server CPU, memory, and disk subsystem.

In a conventional networked storage system, the process of reconciling the copies of a data block after a disk failure is performed via consensus. This approach generally involves the system maintaining an odd number of copies of the data based on the required fault tolerance, typically 3 copies of the data to withstand 1 failure, 5 copies of the data to withstand 2 failures, and/or the like. When the designated leader fails, and a new leader is elected, the new leader can identify when there is an uncommitted write transaction which was inflight before the failure. The new leader then queries all the replicas of the data chunk in order to determine the current state of the replicas. If a majority of the replicas respond, the new leader determines the course of resolution and brings the replicas in a consistent state. If fewer than the majority are online, then the resolution stalls and the data is unavailable until a quorum number of copies become available. Although this reconciliation approach satisfies the functional requirements to provide the necessary storage properties, this approach has a number of downsides and limitations when used in the context of a high-performance primary storage system.

One such limitation with conventional approaches is that the above consensus technique generally requires storing three or five copies of the metadata that physically describes the data stored in each replica. This storage requirement leads to storage amplification. Further, during a write transaction, all the copies need to be updated, leading to reduced system performance. Another such limitation is that recovering data after a failure event, such as a transient failure or a software restart, generally requires a global reconciliation. This global reconciliation is needed to ensure read after read and read after write consistency. However, global reconciliation of data after a failure can be time consuming, thereby further reducing system performance.

As the foregoing indicates, what is needed in the art is methods and systems that allow for more efficient data recovery after disk or node failure in a networked storage system.

### SUMMARY

The disclosed embodiments describe techniques for enabling consistent and durable transactions in a high-performance distributed storage system. The techniques include techniques for rolling back or rolling forward transactions for various data replicas after a disk failure or node restart to ensure read-after-read and read-after-write data consistency.

In various embodiments, one or more non-transitory computer-readable media store program instructions that, when executed by one or more processors of a first cluster, cause the one or more processors to perform a method comprising: receiving, at a first node, a write transaction directed to a first data block of a first extent in an extent group, logging, at the first node, a tentative update in a tentative update journal for a first replica of the first data block, subsequent to logging the tentative update, forwarding the write transaction to a second node, determining that the first node restarted before the write transaction was committed on the first node, and rolling back the write transaction for the first replica. Further embodiments provide, among other things, methods and systems for implementing one or more aspects of the disclosed techniques.

At least one technical advantage of the disclosed techniques relative to prior art is that, with the disclosed techniques a networked storage system can perform parallel write operations across all data replicas, including parallel metadata and data write operations on each node, thereby improving overall write performance. In so doing, the networked storage system can maintain strict read-after-read and read-after-write consistency irrespective of disk or node failure. Further, the networked storage system can service read operations from any data replica, while upholding data consistency guarantees, even if one of the nodes storing data on one of the data replicas is offline. In addition, the networked storage system can service read operations from the secondary data replica without forcing global resolution, thereby improving failure recovery performance and reducing computational costs relative to conventional techniques. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIGS. 1A-1D are block diagrams illustrating virtualization system architectures configured to implement one or more aspects of the present embodiments.

FIG. 2 is a block diagram illustrating a computing environment configured to implement one or more aspects of the present embodiments.

FIG. 3 is a swim-lane diagram illustrating how a write transaction is processed by a storage cluster provided by one or more storage nodes, according to various embodiments.

FIG. 4 is a swim-lane diagram illustrating how a storage cluster recovers from a failure of a primary node in response to a write transaction submitted by a storage client, according to various embodiments.

FIG. 5 is a swim-lane diagram illustrating an alternative scenario of how a storage cluster recovers from a failure of a primary node in response to a write transaction submitted by a storage client, according to various embodiments.

FIG. 6 is a swim-lane diagram illustrating how a storage cluster recovers from a failure of a primary node in response to a write transaction submitted by a storage client, according to various embodiments.

FIG. 7 is a swim-lane diagram illustrating how a storage cluster recovers from a failure of a primary node failure in response to a write transaction submitted by a storage client, according to various embodiments.

FIG. 8 is a swim-lane diagram illustrating how a storage cluster recovers from a failure of a secondary node in response to a write transaction submitted by a storage client, according to various embodiments.

FIG. 9 is a flow diagram of method steps for a primary storage node processing a write transaction from a storage client, according to various embodiments.

FIG. 10 is a flow diagram of method steps for a secondary storage node processing a write transaction from a primary storage node, according to various embodiments.

### DETAILED DESCRIPTION

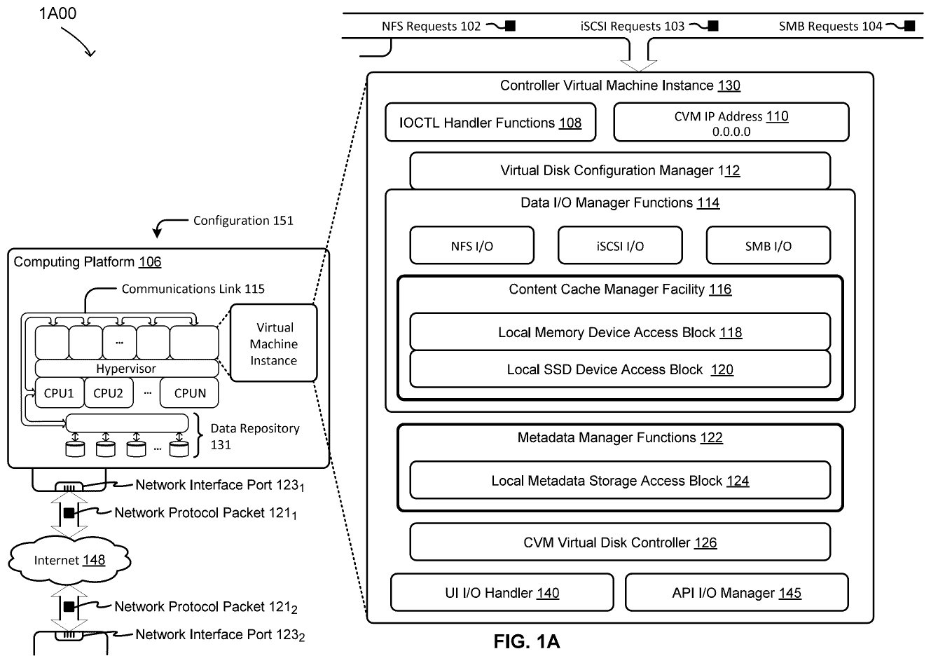

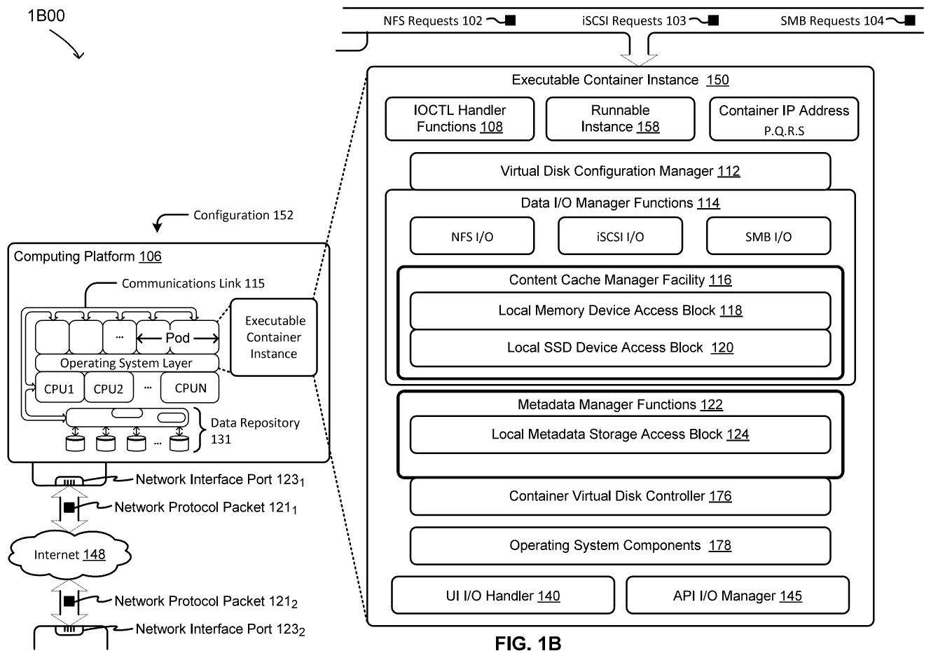

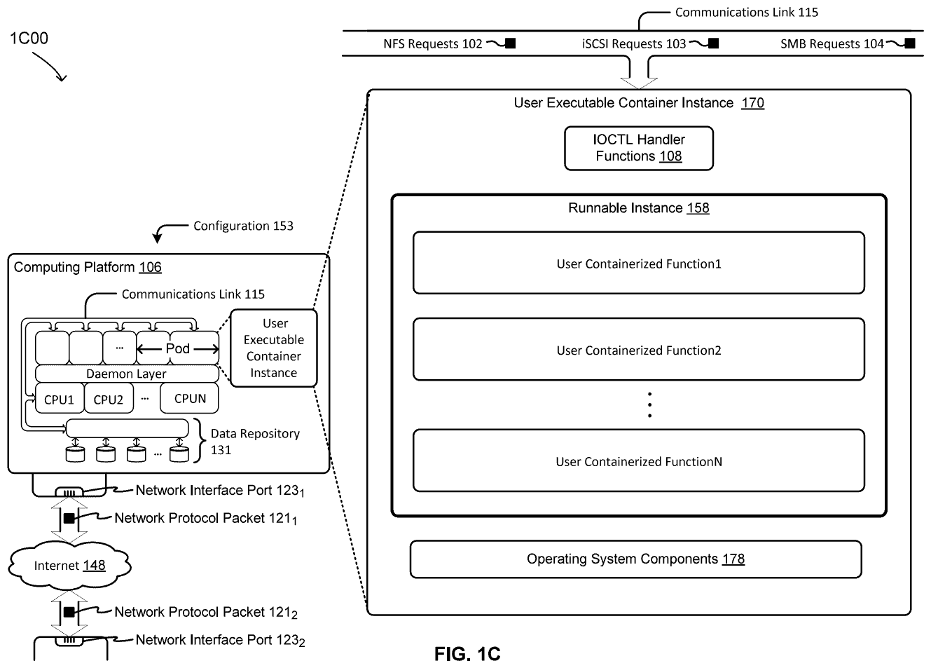

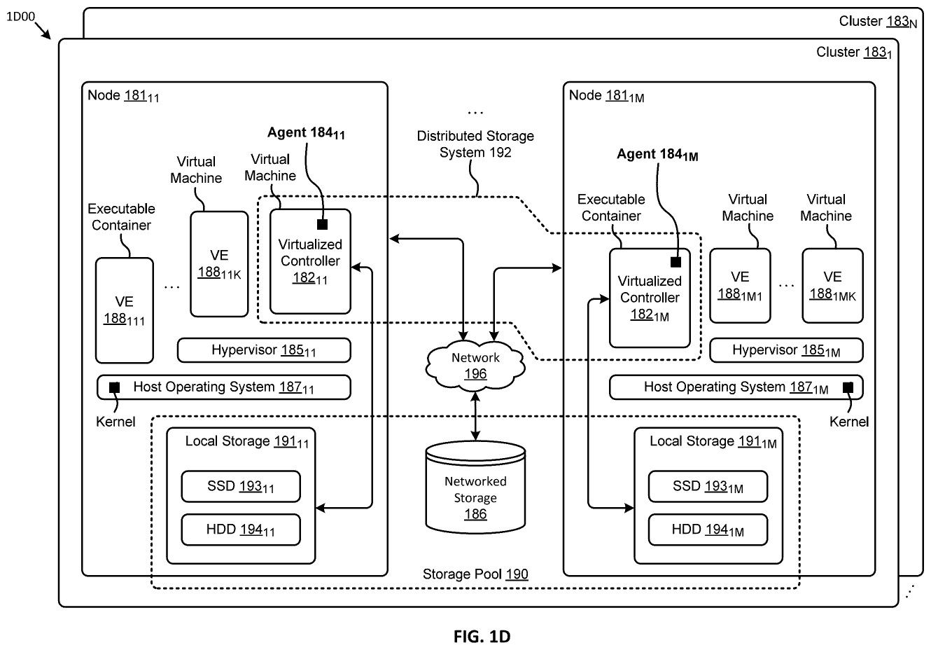

The technical details set forth in Appendices A and B, attached hereto, enable a person skilled in the art to implement the embodiments contemplated and described herein. The techniques described in Appendices A and B can be performed using any of the systems shown and described in conjunction with FIGS. 1A-1D.

In the following description, various concepts and examples are disclosed that provide more effective techniques for storing data across various nodes in a storage cluster. The numerous specific details set forth will provide artisans with a more thorough understanding of the various embodiments. However, it will be apparent to one skilled in the art that the inventive concepts can be practiced without one or more of these specific details.

### Exemplary Virtualization System Architectures

According to some embodiments, all or portions of any of the disclosed techniques can be partitioned into one or more modules and instances within, or as, or in conjunction with a virtualized controller in a virtual computing environment. Some example instances within various virtual computing environments are shown and discussed in further detail in FIGS. 1A-1D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

In some embodiments, a hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 1A is a block diagram illustrating virtualization system architecture 1A00 configured to implement one or more aspects of the present embodiments. As shown in FIG. 1A, virtualization system architecture 1A00 includes a collection of interconnected components, including a controller virtual machine (CVM) instance 130 in a configuration 151. Configuration 151 includes a computing platform 106 that supports virtual machine instances that are deployed as user virtual machines, or controller virtual machines or both. Such virtual machines interface with a hypervisor (as shown). In some examples, virtual machines can include processing of storage I/O (input/output or IO) as received from any or every source within the computing platform. An example implementation of such a virtual machine that processes storage I/O is depicted as CVM instance 130.

In this and other configurations, a CVM instance receives block I/O storage requests as network file system (NFS) requests in the form of NFS requests 102, internet small computer storage interface (iSCSI) block IO requests in the form of iSCSI requests 103, Samba file system (SMB) requests in the form of SMB requests 104, and/or the like. The CVM instance publishes and responds to an internet protocol (IP) address (e.g., CVM IP address 110). Various forms of input and output can be handled by one or more IO control handler functions (e.g., IOCTL handler functions 108) that interface to other functions such as data IO manager functions 114 and/or metadata manager functions 122. As shown, the data IO manager functions can include communication with virtual disk configuration manager 112 and/or can include direct or indirect communication with any of various block IO functions (e.g., NFS IO, ISCSI IO, SMB IO, etc.).

In addition to block IO functions, configuration 151 supports IO of any form (e.g., block IO, streaming IO, packet-based IO, HTTP traffic, etc.) through either or both of a user interface (UI) handler such as UI IO handler 140 and/or through any of a range of application programming interfaces (APIs), possibly through API IO manager 145.

Communications link 115 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry can be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 106 includes one or more computer readable media that is capable of providing instructions to a data processor for execution. In some examples, each of the computer readable media can take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 130 includes content cache manager facility 116 that accesses storage locations, possibly including local dynamic random-access memory (DRAM) (e.g., through local memory device access block 118) and/or possibly including accesses to local solid-state storage (e.g., through local SSD device access block 120).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 131, which in turn can be formatted into any one or more storage areas, and which can comprise parameterized storage accessible by a key (e.g., a filename, a table name, a block address, an offset address, etc.). Data repository 131 can store any forms of data and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 124. The data repository 131 can be configured using CVM virtual disk controller 126, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, . . . , CPUN). According to certain embodiments of the disclosure, two or more instances of configuration 151 can be coupled by communications link 115 (e.g., backplane, LAN, PSTN, wired or wireless network, etc.) and each instance can perform respective portions of sequences of instructions as can be required to practice embodiments of the disclosure.

The shown computing platform 106 is interconnected to the Internet 148 through one or more network interface ports (e.g., network interface port 1231 and network interface port 1232). Configuration 151 can be addressed through one or more network interface ports using an IP address. Any operational element within computing platform 106 can perform sending and receiving operations using any of a range of network protocols, possibly including network protocols that send and receive packets (e.g., network protocol packet 1211 and network protocol packet 1212).

Computing platform 106 can transmit and receive messages that can be composed of configuration data and/or any other forms of data and/or instructions organized into a data structure (e.g., communications packets). In some cases, the data structure includes program instructions (e.g., application code) communicated through the Internet 148 and/or through any one or more instances of communications link 115. Received program instructions can be processed and/or executed by a CPU as it is received and/or program instructions can be stored in any volatile or non-volatile storage for later execution. Program instructions can be transmitted via an upload (e.g., an upload from an access device over the Internet 148 to computing platform 106). Further, program instructions and/or the results of executing program instructions can be delivered to a particular user via a download (e.g., a download from computing platform 106 over the Internet 148 to an access device).

Configuration 151 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013,which is hereby incorporated by reference in its entirety.

FIG. 1B depicts a block diagram illustrating another virtualization system architecture 1B00 configured to implement one or more aspects of the present embodiments. As shown in FIG. 1B, virtualization system architecture 1B00 includes a collection of interconnected components, including an executable container instance 150 in a configuration 152. Configuration 152 includes a computing platform 106 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http: ”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node can communicate directly with storage devices on the second node.

The operating system layer can perform port forwarding to any executable container (e.g., executable container instance 150). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and can include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is” or “Is -a”, etc.). The executable container might optionally include operating system components 178, however such a separate set of operating system components need not be provided. As an alternative, an executable container can include runnable instance 158, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 176. Such a container virtual disk controller can perform any of the functions that the aforementioned CVM virtual disk controller 126 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 1C is a block diagram illustrating virtualization system architecture 1C00 configured to implement one or more aspects of the present embodiments. As shown in FIG. 1C, virtualization system architecture 1000 includes a collection of interconnected components, including a user executable container instance in configuration 153 that is further described as pertaining to user executable container instance 170. Configuration 153 includes a daemon layer (as shown) that performs certain functions of an operating system.

User executable container instance 170 comprises any number of user containerized functions (e.g., user containerized function1, user containerized function2, . . . ,user containerized functionN). Such user containerized functions can execute autonomously or can be interfaced with or wrapped in a runnable object to create a runnable instance (e.g., runnable instance 158). In some cases, the shown operating system components 178 comprise portions of an operating system, which portions are interfaced with or included in the runnable instance and/or any user containerized functions. In some embodiments of a daemon-assisted containerized architecture, computing platform 106 might or might not host operating system components other than operating system components 178. More specifically, the shown daemon might or might not host operating system components other than operating system components 178 of user executable container instance 170.

In some embodiments, the virtualization system architecture 1A00, 1B00, and/or 1C00 can be used in any combination to implement a distributed platform that contains multiple servers and/or nodes that manage multiple tiers of storage where the tiers of storage might be formed using the shown data repository 131 and/or any forms of network accessible storage. As such, the multiple tiers of storage can include storage that is accessible over communications link 115. Such network accessible storage can include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 151) to manage the interactions between the underlying hardware and user virtual machines or containers that run client software.

Distinct from user virtual machines or user executable containers, a special controller virtual machine (e.g., as depicted by controller virtual machine instance 130) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 1D is a block diagram illustrating virtualization system architecture 1D00 configured to implement one or more aspects of the present embodiments. As shown in FIG. 1D, virtualization system architecture 1D00 includes a distributed virtualization system that includes multiple clusters (e.g., cluster 183₁, . . . , cluster 183_{N}) comprising multiple nodes that have multiple tiers of storage in a storage pool. Representative nodes (e.g., node 181₁₁, . . . , node 1811_{M}) and storage pool 190 associated with cluster 183₁ are shown. Each node can be associated with one server, multiple servers, or portions of a server. The nodes can be associated (e.g., logically and/or physically) with the clusters. As shown, the multiple tiers of storage include storage that is accessible through a network 196, such as a networked storage 186 (e.g., a storage area network or SAN, network attached storage or NAS, etc.). The multiple tiers of storage further include instances of local storage (e.g., local storage 191₁₁, . . . , local storage 191_{1M}). For example, the local storage can be within or directly attached to a server and/or appliance associated with the nodes. Such local storage can include solid state drives (SSD 193₁₁, . . . , SSD 193_{1M}), hard disk drives (HDD 194₁₁, . . . , HDD 194_{1M}), and/or other storage devices.

As shown, any of the nodes of the distributed virtualization system can implement one or more user virtualized entities (e.g., VE 188¹¹¹, . . . , VE 188^{11K}, . . . , VE 188^{1M1}, . . . , VE 188^{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 187¹¹, . . . , host operating system 187^{1M}), while the VMs run multiple applications on various respective guest operating systems. Such flexibility can be facilitated at least in part by a hypervisor (e.g., hypervisor 185¹¹, . . . , hypervisor 185^{1M}), which hypervisor is logically located between the various guest operating systems of the VMs and the host operating system of the physical infrastructure (e.g., node).

As an alternative, executable containers can be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 187₁₁, . . . , host operating system 187_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 190 by the VMs and/or the executable containers.

Multiple instances of such virtualized controllers can coordinate within a cluster to form the distributed storage system 192 which can, among other operations, manage the storage pool 190. This architecture further facilitates efficient scaling in multiple dimensions (e.g., in a dimension of computing power, in a dimension of storage space, in a dimension of network bandwidth, etc.).

In some embodiments, a particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 181₁₁can interface with a controller virtual machine (e.g., virtualized controller 18211) through hypervisor 185₁₁ to access data of storage pool 190. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 192. For example, a hypervisor at one node in the distributed storage system 192 might correspond to software from a first vendor, and a hypervisor at another node in the distributed storage system 192 might correspond to a second software vendor. As another virtualized controller implementation example, executable containers can be used to implement a virtualized controller (e.g., virtualized controller 182_{1M}) in an operating system virtualization environment at a given node. In this case, for example, the virtualized entities at node 181_{1M} can access the storage pool 190 by interfacing with a controller container (e.g., virtualized controller 182_{1M}) through hypervisor 185_{1M} and/or the kernel of host operating system 187_{1M}.

In some embodiments, one or more instances of an agent can be implemented in the distributed storage system 192 to facilitate the herein disclosed techniques. Specifically, agent 184₁₁ can be implemented in the virtualized controller 182₁₁, and agent 184_{1M} can be implemented in the virtualized controller 182_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or the agents.

### Storage Nodes in a Storage Cluster

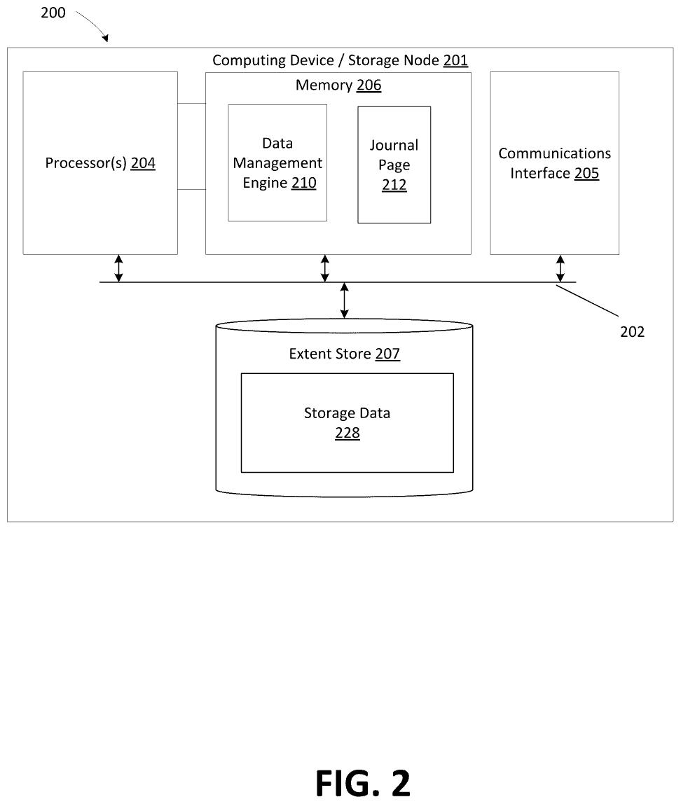

FIG. 2 is a block diagram illustrating a computing environment 200 configured to implement one or more aspects of the present embodiments. As shown, the computing environment 200 includes, without limitation, a computing device or storage node 201. The storage node 201 includes, without limitation, a bus 202, one or more processors 204, a communications interface 205, a memory 206, and an extent store 207. Memory 206 includes, without limitation, a data management engine 210 and a journal page 212. The extent store 207 includes, without limitation, storage data 228. While journal page 212 is depicted in the memory 206, the journal page 212 can also be stored in the extent store 207 or other a disk associated with storage node 201. The journal page 212 is also referred to herein as a pending transaction journal 212. The components of the computing environment 200 of FIG. 2 can be included in any of the virtualization system architectures shown in FIGS. 1A-1D.

Storage node 201 can be deployed as one of multiple storage nodes 201 in a storage cluster. A storage cluster can also provide virtual disk capabilities to other workloads, such as virtual machines that are executed in the virtualization system architectures shown in FIGS. 1A-1D. By utilizing multiple storage nodes, a storage cluster can replicate data among multiple storage nodes to provide data redundancy and availability. Other systems that read or write data from a storage cluster provided by one or more storage nodes 201 are also referred to herein as storage clients. A storage node 201 can operate as a leader node or a secondary node in a storage cluster. In some implementations, a storage node 201 can be a leader node with respect to one transaction but operate as a secondary node with respect to another transaction.

The bus 202 interconnects subsystems and devices within storage node 201, such as the one or more processors 204, the communications interface 205, memory 206, and extent store 207. The computing environment 200 described herein is illustrative and any other technically feasible configurations fall within the scope of the present disclosure. Further, in the context of this disclosure, the computing elements shown in the computing environment 200 can correspond to a physical computing system (e.g., a system in a data center) or can include a virtual computing instance.

The one or more processors 204 include any suitable processors implemented as a central processing unit (CPU), a graphics processing unit (GPU), an application-specific integrated circuit (ASIC), a field programmable gate array (FPGA), an artificial intelligence (Al) accelerator, any other type of processor, or a combination of different processors, such as a CPU configured to operate in conjunction with a GPU. In general, one or more processors 204 can be any technically feasible hardware unit capable of processing data and/or executing software applications.

Memory 206 includes a random-access memory (RAM) module, a flash memory unit, and/or any other type of memory unit or combination thereof. The one or more processors 204 are configured to read data from and write data to memory 206. Memory 206 includes various software programs that include one or more instructions that can be executed by the one or more processors 204 and application data associated with said software programs.

Data management engine 210 includes executable instructions such as a program or application that performs data management operations for the extent store 207. Data management operations include receiving and processing read and/or write transactions from a storage client utilizing the storage cluster, garbage collection, lifecycle management, and other actions. For example, a storage client such as a virtual machine stores data in a virtual disk that is provided by a storage cluster. The storage cluster writes replicas of data from the virtual machine at one or more storage nodes 201 in the storage cluster. When the virtual machine reads the data from the virtual disk, the storage cluster retrieves a replica of the data from one or more of the storage nodes 201. Garbage collection includes identifying and reclaiming data areas within a storage node 201 when the data stored in that location is no longer needed or utilized according to data management rules. Lifecyle management includes moving data from one storage node 201 to another storage node 201 according to data management rules. For example, lifecycle management can include moving data that is infrequently used from an SSD to an HDD, moving data that is frequently used from an HDD to an SDD, and other data movement decisions. Virtual machines or other workloads that are provided access to virtual disks by a storage cluster powered by data management engine 210 need not have knowledge of lifecycle management, garbage collection, or other data management processes that enable storage of data on behalf of the workloads among storage nodes of the storage cluster.

In a cluster of storage nodes 201, a leader is elected. In one embodiment, a leader storage node 201 is designated manually by a user. In another embodiment, a leader is elected by the storage nodes 201 using a leader election algorithm. A leader node is also referred to herein as a primary node while the other nodes in the cluster that are not leaders are referred to as secondary nodes. Accordingly, a storage client submits a write transaction to the storage cluster by submitting the write transaction to a primary storage node 201. The primary storage node 201 stores a tentative update entry corresponding to the write transaction in a pending transaction journal, or the journal page 212. The journal page 212 is stored in memory 206 or on a disk associated with storage node 201. In one implementation, the journal page 212 comprises a single storage page that includes all of the pending transaction records associated with write operations associated with the extent store 207, or a disk of the storage node 201. Pending transactions are transactions that have not yet been committed to the extent store 207.

The records in the journal page 212 represent pending transactions that are in the process of being stored to the extent store 207 by the data management engine 210. For example, data management engine 210 receives a write transaction from a storage client that includes data to be written to the extent store 207. If the storage node 201 on which data management engine 210 is executing represents the primary storage node 201, information about the write transaction is stored in the journal page 212 and the write transaction is forwarded to one or more secondary storage nodes in the storage cluster that will also store replicas of the data. The information about a write transaction that is stored in the journal page 212 is also referred to as the tentative update entry. The tentative update entry in the journal page 212 includes an identifier of an extent group in the extent store 207 to which data is being written, an extent index representing an extent within the extent group to which data is being written, and a logical transaction sequence identifier that can represent a monotonically increasing identifier that identifies the write transaction.

As noted above, after the tentative update entry is logged by the primary storage node 201, the data management engine 210 on the primary storage node 201 forwards the write transaction to the one or more other nodes in the storage cluster, or to one or more secondary storage nodes 201. Upon receiving acknowledgement that the secondary storage nodes 201 have written a replica of data corresponding to the write transaction to their respective extent stores 207, the primary storage node 201 locally commits the write transaction to store a replica of the data to its own extent store 207 and removes the tentative update entry from its journal page 212. Next, data management engine 210 on the primary storage node 201 propagates a commit instruction to the secondary storage nodes 201 and acknowledges completion of the write transaction to the storage client that submitted the write transaction to the storage cluster. A secondary storage node 201 also logs a tentative update entry in response to receiving a write transaction forwarded from a primary storage node 201. When the secondary storage node 201 locally commits the write transaction to its extent store 207, data management engine 210 removes the tentative update entry from the journal page 212 on the secondary storage node 201.

The data management engine 210 provides read-after-write and read-after-read consistency by implementing rules that govern the order in which the steps for processing a write transaction are performed. The rules also govern whether a particular write transaction is rolled forward or backward on a particular storage node 201. The rules applicable to a storage node 201 are dependent upon whether a storage node 201 is operating as a primary node or a secondary node in the storage cluster. Data management engine 210 provides consistency and durability guarantees to storage clients reading and writing data from a storage cluster while providing the ability to perform parallel writes across the storage nodes 201 in a given cluster. Strict read-after-read and read-after-write consistency is also provided as well as the ability to service reads from any of the storage nodes 201 while upholding consistency and durability guarantees, even if a particular storage node 201 in the cluster has suffered a failure. Additionally, data management engine 210 can service reads from a secondary storage node 201 without forcing global resolution between the storage nodes 201 in the cluster.

The first rule implemented by data management engine 210 is that a primary storage node 201 among a cluster of storage nodes 201 must durably log a tentative update entry corresponding to a write transaction received from a storage client before forwarding the write transaction to secondary storage nodes 201 within the cluster. The second rule implemented by data management engine 210 is that during failure recovery or restart, a primary storage node 201 must always roll back any transactions for which tentative update entries are stored in the journal page 212 on the primary storage node 201. In other words, any in-flight transactions are always rolled back by the primary storage node 201 if the transactions have not been committed by the primary storage node 201. The third rule implemented by storage node 201 is that during failure recovery or restart, a secondary storage node 201 must always roll forward any transactions for which tentative update entries are stored in the journal page 212 on the secondary storage node 201. In other words, any transactions that have not been locally committed to the extent store 207 on the secondary storage node 201 are rolled forward, or committed, by the secondary storage node 201. The fourth rule implemented by data management engine 210 is that a primary storage node 201 must locally commit a write transaction to its respective extent store 207 before acknowledging the write transaction to the storage client and before instructing secondary storage nodes 201 in the cluster to commit the write transaction to their respective extent stores 207. Once the primary storage node 201 locally commits the transaction to its extent store extent store 207, the write transaction is considered globally committed because the write transaction is acknowledged to the requesting storage client.

Extent store 207 includes, without limitation, non-volatile storage for applications and data, and may include one or more fixed or removable disk drives, HDDs, SSD, NVMes, vDisks, flash memory devices, and/or other magnetic, optical, and/or solid-state storage devices. The extent store 207 can include physical storage devices of a storage cluster. The physical storage devices include, without limitation, non-volatile storage for applications and data, and may include one or more fixed or removable disk drives, HDDs, SSD, NVMes, vDisks, flash memory devices, and/or other magnetic, optical, and/or solid-state storage devices. Extent store 207 stores data that is housed in the storage cluster and assigned to storage in the storage node 201 operating as a storage node in the cluster. Extent store 207 stores metadata or other information about data stored in the extent store 207. For example, storage data 228 includes the data stored by the storage node 201. The data stored by the server is also referred to as extents. An extent is a unique piece of data stored by the storage node 201. An extent can be referenced by or accessed by one or more virtual disks that are stored in a storage cluster by virtual machines, for example. An extent group represents a group of extents that are, for example, stored in a single file. An extent and extent group can be assigned unique identifiers that are referenced by metadata stored in the extent store 207.

### Processing a Write Transaction in the Storage Cluster

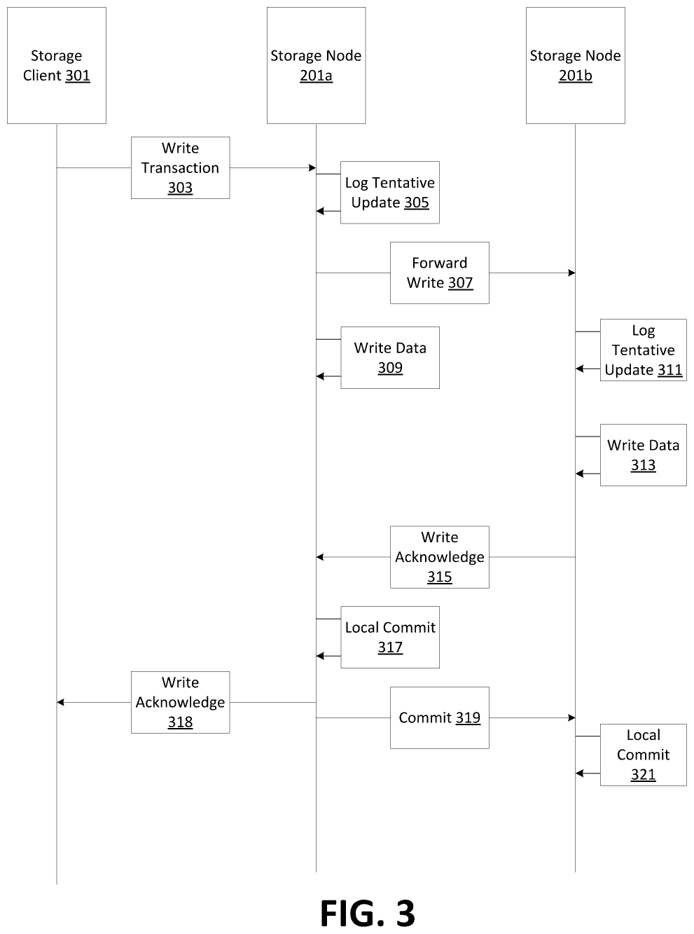

FIG. 3 is a swim-lane diagram illustrating how a write transaction is processed by a storage cluster provided by one or more storage nodes 201, according to various embodiments. In the swim-lane diagrams that follow, a write transaction is processed by a primary storage node, identified as storage node 201a, and a secondary storage node, identified as storage node 201b. It should be appreciated that multiple secondary storage nodes can be utilized and that the depiction of a single secondary storage node is for ease of depiction. First, at step 303 storage client 301 submits a write transaction to storage node 201a. The write transaction corresponds to data that the storage client 301 is attempting to store in a storage cluster, for example. At step 305, storage node 201a logs a tentative update entry to the journal page 212 on the storage node 201a. The tentative update entry includes information about write transactions that are in-flight, or that are uncommitted to the extent store 207. A respective tentative update entry includes, for example, an extent group identifier identifying an extent group being modified or written by a write transaction, an extent index identifying an extent within the extent group that is being updated, and a logical transaction sequence identifier that comprises an identifier of the write transaction. Data management engine 210 writes a tentative update entry 405 to the journal page 212 to indicate that there is a pending transaction on a particular extent within an extent group in the extent store 207.

At step 307, after logging the tentative update entry to the journal page 212, storage node 201a forwards the write transaction to storage node 201b, or the secondary storage node 201. At step 309, storage node 201a writes a replica of the data from the write transaction to its extent store 207 but does not commit the write transaction at this time. For example, in one scenario, the write transaction comprises an edit to previously stored data in the storage cluster at certain data blocks. Accordingly, at step 309, data management engine 210 on storage node 201a writes data from to the write transaction to data blocks in storage data 228 that are separate from the data previously stored at those data blocks. If and when the write transaction is later committed, data management engine 210 updates a pointer to the previously stored data to the storage location of the new data blocks.

At step 311, storage node 201b logs a tentative update entry to the journal page 212 on the storage node 201b. At step 313, storage node 201b writes a replica of the data from the write transaction to its extent store 207 but does not commit the write transaction 203 at this time. At step 315, storage node 201b acknowledges the write transaction to the data management engine 210 running on storage node 201a. At step 317, in response to receiving an acknowledgement from the storage node 201b and any other secondary storage nodes 201 in the cluster, data management engine 210 on storage node 201a locally commits the write transaction to the extent store 207. The process of committing the storage client 301 to the extent store 207 includes removing the tentative update entry corresponding to the write transaction from the journal page 212 of the storage node 201a. From this point forward, any storage client 301 requesting the data submitted to the storage cluster from the write transaction will receive, in response, the newly written data. In the event of a failure of storage node 201a, storage node 201b or any other secondary storage node from this point forward, the newly written data is returned to a storage client requesting the data from the write transaction because as noted above, a secondary storage node rolls the write transaction forward in the event of a failure of the secondary storage node. In this way, data management engine 210 running on the storage nodes 201a, 201b provides read-after-write consistency. At step 323, data management engine 210 on storage node 201a acknowledges the write transaction to the storage client 301.

At step 319, storage node 201a transmits an instruction to storage node 201b and any other secondary storage nodes 201 to commit the write transaction 203 to their respective extent stores 207. At step 321, storage node 201b locally commits the write transaction to its respective extent store 207.

### Recovery From a Primary Node Failure

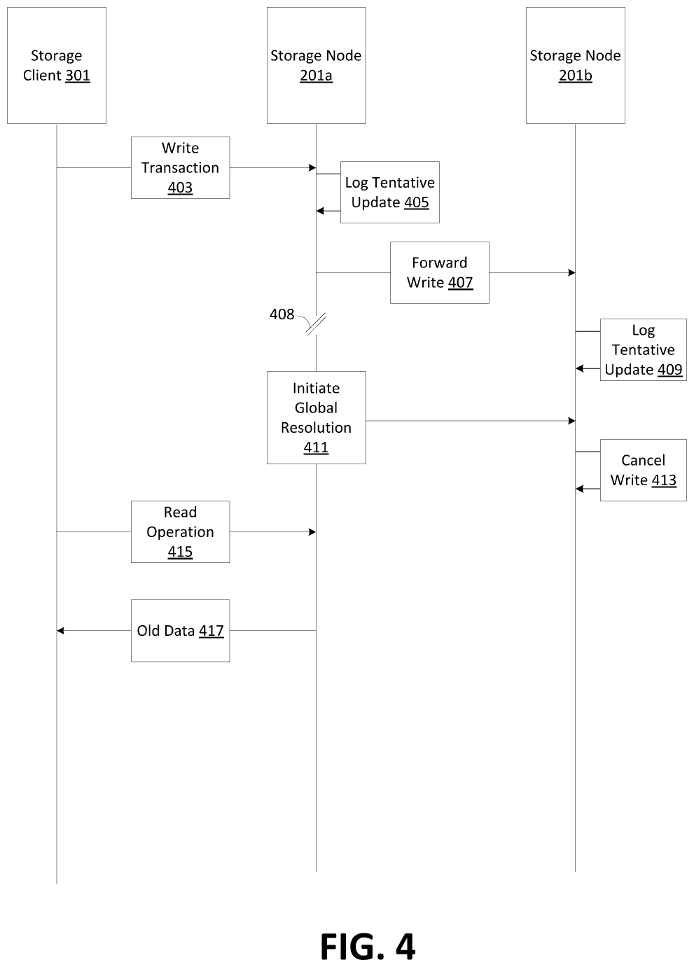

FIG. 4 is a swim-lane diagram illustrating how a storage cluster recovers from a failure of a primary node in response to a write transaction submitted by a storage client 301, according to various embodiments. First, at step 403, storage client 301 submits a write transaction to storage node 201a. Again, the write transaction corresponds to data that the storage client 301 is attempting to update in a storage cluster. At step 405, storage node 201a logs a tentative update entry to the journal page 212 on the storage node 201a. The tentative update entry includes information about write transactions that are in-flight, or that are uncommitted to the extent store 207. At step 407, after logging the tentative update entry to the journal page 212, storage node 201a forwards the write transaction to storage node 201b, or the secondary storage node 201. At step 408, assume that storage node 201a suffers a failure, which could include a disk failure. In the example of FIG. 4, the failure occurs before the storage node 201b acknowledges the write transaction to the storage node 201a and before storage node 201a commits the write transaction or acknowledges the write transaction to storage client 301. At step 409, storage node 201b logs a tentative update entry corresponding to the storage client 301 in its journal page 212 based on the write transaction received from storage node 201a at step 407.

Accordingly, at step 411, after recovery from the failure at step 408, data management engine 210 initiates global resolution because the write transaction was sent to the storage node 201b but the data from the write transaction was never written to the extent store 207 by storage node 201a. Additionally, data management engine 210 initiates global resolution because upon recovery from failure, data management engine 210 recovers journal page 212 and determines that a tentative update entry corresponding to the write transaction is still stored in journal page 212. To accomplish global resolution, storage node 201a rolls back the write transaction so that the new data from the write transaction is not stored in the extent store 207. Storage node 201a also instructs storage node 201b to cancel the write transaction. In response, at step 413, storage node 201b cancels or rolls back the write transaction. Subsequently, a read operation 415 received from storage client 301 by storage node 201a returns the old data 417 to the storage client 301, or the data that was previously stored at the data blocks before the write transaction was received.

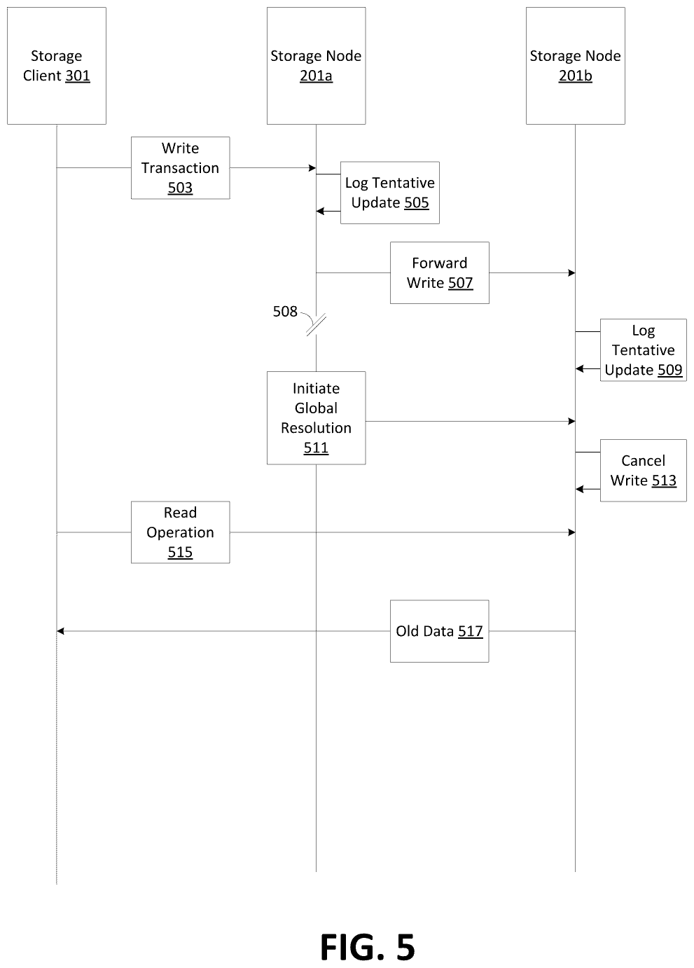

FIG. 5 is a swim-lane diagram illustrating an alternative scenario of how a storage cluster recovers from a failure of a primary node in response to a write transaction submitted by a storage client 301, according to various embodiments. First, at step 503, storage client 301 submits a write transaction to storage node 201a. At step 505, storage node 201a logs a tentative update entry to the journal page 212 on the storage node 201a. The tentative update entry includes information about write transactions that are in flight, or that are uncommitted to the extent store 207. At step 507, after logging the tentative update entry to the journal page 212, storage node 201a forwards the write transaction to storage node 201b, or the secondary storage node 201. At step 508, assume that storage node 201a suffers a failure. In the example of FIG. 4, the failure occurs before the storage node 201b acknowledges the write transaction to the storage node 201a and before storage node 201a commits the write transaction or acknowledges the write transaction to storage client 301. At step 509, storage node 201b logs a tentative update entry corresponding to the storage client 301 in its journal page 212.

Accordingly, at step 511, after recovery from the failure at step 508, data management engine 210 initiates global resolution. To accomplish global resolution, storage node 201a rolls back the write transaction so that the new data is not overwritten onto the old data. Storage node 201a also instructs storage node 201b to cancel the write transaction. In response, at step 513, storage node 201b cancels or rolls back the write transaction. Subsequently, a read operation 515 is received from storage client 301 by storage node 201b. At step 517, storage node 201b returns the old data to the storage client 301, or the data stored prior to receiving the write transaction. As illustrated in FIGS. 4-5, no matter which storage node 201 receives the read operation, the same data is returned to the storage client 301 because neither storage node 201a nor storage node 201b committed the write transaction.

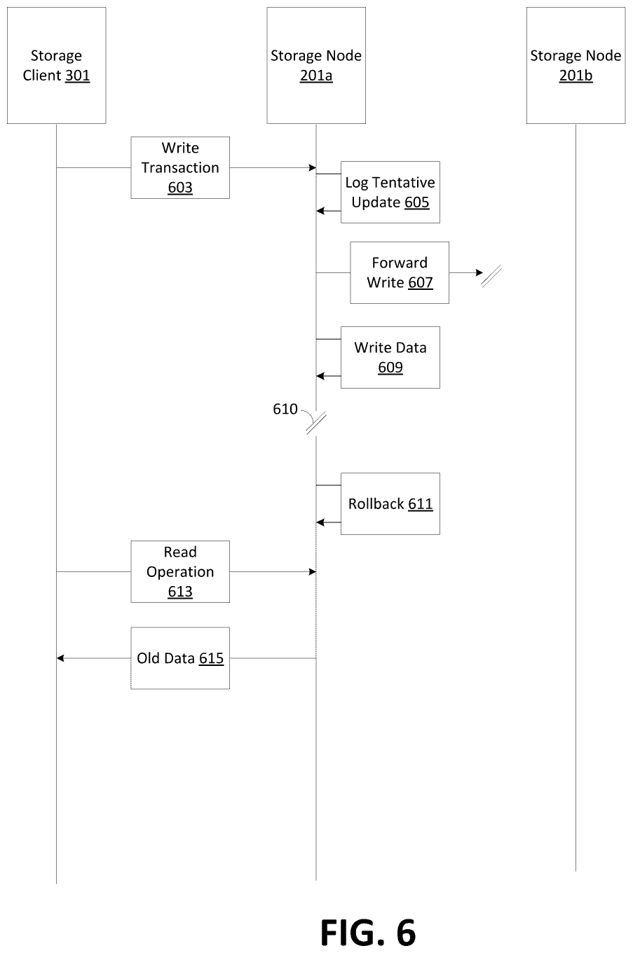

FIG. 6 is a swim-lane diagram illustrating how a storage cluster recovers from a failure of a primary node in response to a write transaction submitted by a storage client 301, according to various embodiments. First, at step 603, storage client 301 submits a write transaction to storage node 201a. Again, the write transaction corresponds to data that the storage client 301 is attempting to update in a storage cluster. At step 605, storage node 201a logs a tentative update entry to the journal page 212 on the storage node 201a. At step 607, after logging the tentative update entry to the journal page 212, storage node 201a forwards the write transaction to storage node 201b, but the write transaction is unsuccessfully forwarded to storage node 201b or there is a failure of storage node 201b. At step 609, storage node 201a writes the data from the write transaction to its extent store 207 but does not commit the write transaction 203 at this time. At step 610, now assume that storage node 201a suffers a failure. Upon recovering from the failure, at step 611, storage node 201a rolls back the write transaction.

Therefore, a subsequent read transaction from a storage client 301 at step 613 results in the storage node 201a returning the old data at step 615, as the write transaction was rolled back at step 611.

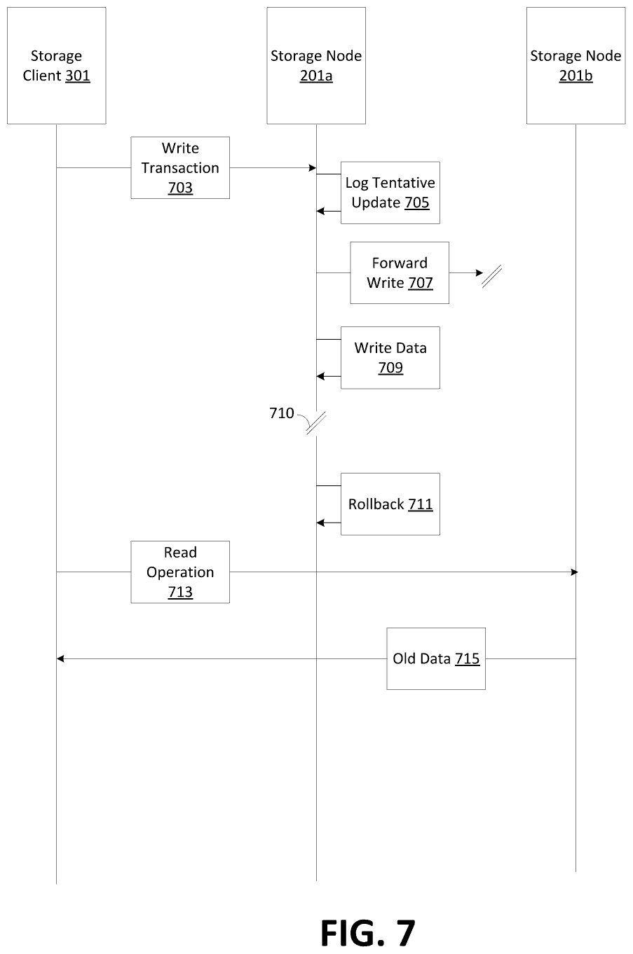

FIG. 7 is another swim-lane diagram illustrating how a storage cluster recovers from a failure of a primary node failure in response to a write transaction submitted by a storage client 301, according to various embodiments. First, at step 703, storage client 301 submits a write transaction to storage node 201a. At step 705, storage node 201a logs a tentative update entry corresponding to the write transaction to the journal page 212 on the storage node 201a. At step 707, after logging the tentative update entry to the journal page 212, storage node 201a forwards the write transaction to storage node 201b, but the write transaction is unsuccessfully forwarded to storage node 201b or there is a failure of storage node 201b. At step 709, storage node 201a writes the data from the write transaction to its extent store 207 but does not commit the write transaction 203 at this time. At step 710, assume that storage node 201a suffers a failure. Accordingly, at step 711, storage node 201a rolls back the write transaction.

Therefore, a subsequent read operation from a storage client 301 at step 713 results in the storage node 201b returning the old data at step 715. As illustrated in FIGS. 6-7, no matter which storage node 201 receives the read operation, the same replica of data is returned to the storage client 301 because neither storage node 201a nor storage node 201b committed the write transaction.

### Recovery From a Secondary Node Failure

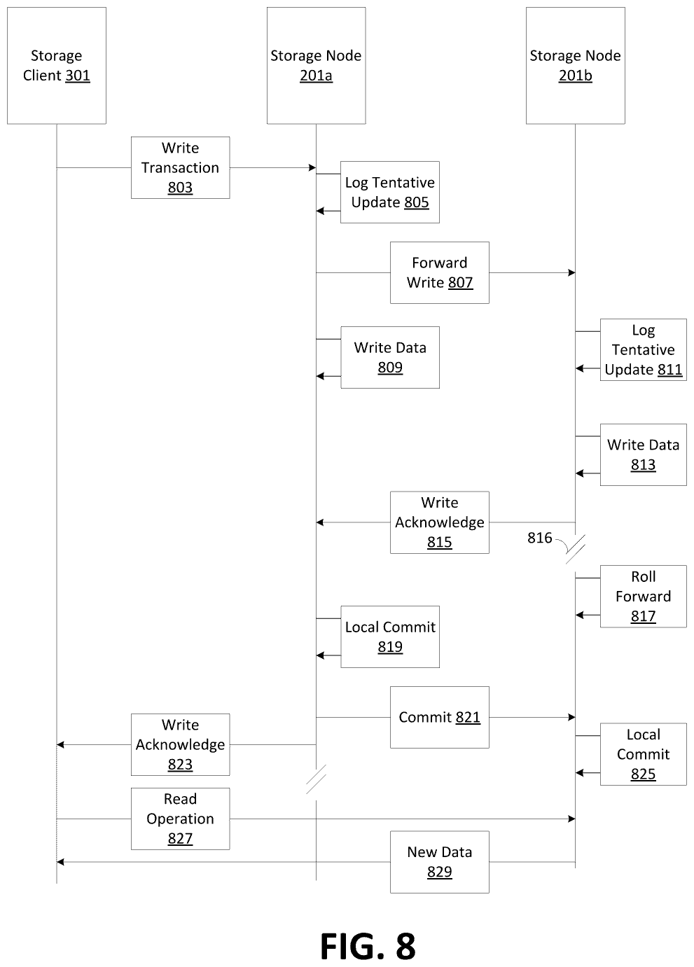

FIG. 8 is a swim-lane diagram illustrating how a storage cluster recovers from a failure of a secondary node in response to a write transaction submitted by a storage client 301, according to various embodiments. First, at step 803, storage client 301 submits a write transaction to storage node 201a. At step 805, storage node 201a logs a tentative update entry to the journal page 212 on the storage node 201a. At step 807, after logging the tentative update entry to the journal page 212, storage node 201a forwards the write transaction to storage node 201b, or the secondary storage node 201. At step 809, storage node 201a writes the data from the write transaction to its extent store 207 but does not commit the write transaction 203 at this time. For example, in one scenario, a write transaction comprises an edit to previously stored data in the storage cluster. Accordingly, at step 809, data management engine 210 on storage node 201a writes new data corresponding to the write transaction to blocks in storage data 228 that are separate from the old data. If and when the write transaction is later committed, data management engine 210 updates a pointer to the previously stored data to the storage location of the new data.

At step 811, storage node 201b logs a tentative update entry to the journal page 212 on the storage node 201b. At step 813, storage node 201b writes the data from the write transaction to its extent store 207 but does not commit the write transaction 203 at this time. At step 815, storage node 201b acknowledges the write transaction to storage node 201a. At step 816, assume that storage node 201b suffers a failure. Accordingly, at step 817, data management engine 210 running on storage node 201b, upon recovery from the failure, determines that a tentative update entry corresponding to write transaction is stored in the journal page 212 of storage node 201b. In contrast to a primary node, which rolls back the write transaction in response to recovery from a failure, storage node 201b rolls forward the transaction by determining whether the new data was written to the extent store 207. If the new data was not written to the extent store 207, the data management engine 210 writes the data to the extent store 207 at step 817.

At step 819, in response to receiving an acknowledgement from the storage node 201b and any other secondary storage nodes 201 in the cluster, data management engine 210 on storage node 201a locally commits the write transaction to the extent store 207. At step 821, storage node 201a transmits an instruction to storage node 201b and any other secondary storage nodes 201 to commit the write transaction 203 to their respective extent stores 207. At step 823, data management engine 210 on storage node 201a acknowledges the write transaction to the storage client 301. At step 825, storage node 201b locally commits the write transaction to its respective extent store 207.

Therefore, a subsequent read operation from a storage client 301 at step 827 results in the storage node 201b returning the new data at step 829. Regardless of which storage node 201 receives a read operation from storage client 301, the new data is returned to a requesting storage client 301.

### Primary Storage Node

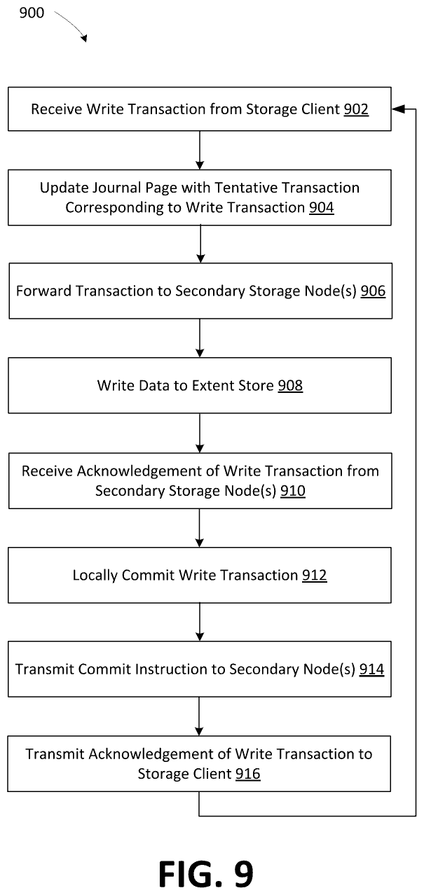

FIG. 9 is a flow diagram of method steps for a primary storage node processing a write transaction from a storage client, according to various embodiments. Although the method steps are described in conjunction with the systems of FIGS. 1-8, persons of ordinary skill in the art will understand that any system configured to perform the method steps, in any order, is within the scope of the invention.

As shown, a method 900 begins at step 902, where the data management engine 210 running on a primary storage node receives a write transaction. The write transaction is received from or on behalf of a storage client, such as a virtual machine storing or editing data in a storage cluster. At step 904, data management engine 210 updates the journal page with a tentative update entry corresponding to the write transaction. The information in the tentative update entry facilitates determination of whether a transaction should be rolled back in the event of a failure of the primary storage node 201.

At step 906, data management engine 210 forwards the write transaction to one or more secondary storage nodes, which are storage nodes 201 executing data management engine 210 operating as a secondary storage node. For example, data management engine 210 can use the one or more secondary storage nodes to store replicas of the data in the write transaction.

At step 908, data management engine 210 writes the data from the write transaction to the extent store 207. The data management engine 210 does not commit the transaction at this time because the primary storage node 201 waits for the secondary storage nodes to acknowledge the write transaction. At step 910, data management engine 210 receives acknowledgement of the write transaction from the one or more secondary storage nodes 201.

At step 912, upon receiving acknowledgement of the write transaction from the other storage nodes 201 in the storage cluster, data management engine 210 locally commits the write transaction. At step 914, data management engine 210 transmits a commit instruction to the secondary storage nodes 201. At step 916, data management engine 210 transmits an acknowledgement of the write transaction to the storage client 301 that submitted the write transaction at step 902.

### Secondary Storage Node

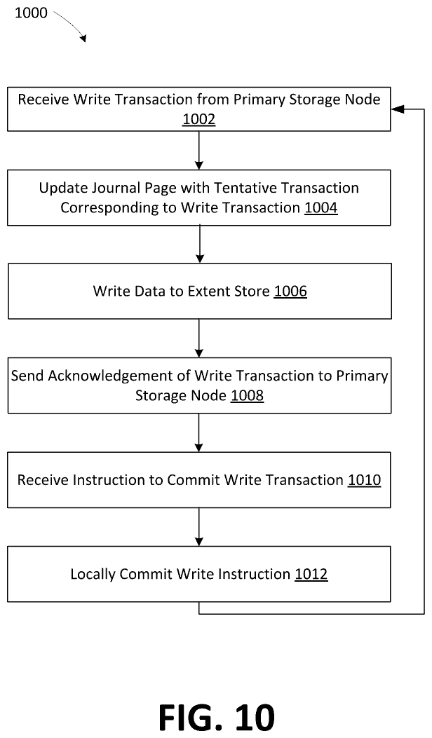

FIG. 10 is a flow diagram of method steps for a secondary storage node processing a write transaction from a primary storage node, according to various embodiments. Although the method steps are described in conjunction with the systems of FIGS. 1-8, persons of ordinary skill in the art will understand that any system configured to perform the method steps, in any order, is within the scope of the invention.

As shown, a method 1000 begins at step 1002, where the data management engine 210 running on a secondary storage node receives a write transaction from a primary storage node. At step 1004, data management engine 210 updates the journal page with a tentative update entry corresponding to the write transaction. The information in the tentative update entry facilitates determination of whether a transaction should be rolled forward in the event of a failure of the secondary storage node 201.

At step 1006, data management engine 210 writes the data from the write transaction to the extent store 207. The data management engine 210 does not commit the transaction at this time because the secondary storage node 201 waits for a commit instruction from the primary storage node 201. At step 1008, data management engine 210 sends an acknowledgement of the write transaction to the primary storage node 201. At step 1010, receives a commit instruction from the primary storage node 201. Upon receiving the commit instruction, data management engine 210 locally commits the write transaction on the secondary storage node 201 at step 1012.

In sum, the disclosed techniques include receiving, at a first node, a write transaction directed to a first data block of a first extent in an extent group. A tentative update corresponding to the write transaction is logged at the first node. Subsequent to logging the tentative update, the first node forwards the write transaction to a second node. If the first node suffers a failure before receiving an acknowledgement of the write transaction from the second node, before locally committing the write transaction, before propagating a commit instruction to the second node, or before acknowledging the write transaction to a storage client, the first node rolls back the write transaction. If the second node suffers a failure after receiving the write transaction, the second node rolls forward the write transaction even if the failure occurs before the second node commits the write transaction.

At least one technical advantage of the disclosed techniques relative to prior art is that, with the disclosed techniques a networked storage system can perform parallel write operations across all data replicas, including parallel metadata and data write operations on each node, thereby improving overall write performance. In so doing, the networked storage system can maintain strict read-after-read and read-after-write consistency. Further, the networked storage system can service read operations from any data replica, while upholding data consistency guarantees, even if one of the nodes storing data on one of the data replicas is offline. In addition, the networked storage system can service read operations from the secondary data replica without forcing global resolution, thereby improving failure recovery performance relative to conventional techniques. These technical advantages provide one or more technological improvements over prior art approaches.
1. In some embodiments, one or more non-transitory computer-readable media store program instructions that, when executed by one or more processors of a first cluster, cause the one or more processors to perform a method comprising receiving, at a first node, a write transaction directed to a first data block of a first extent in an extent group, logging, at the first node, a tentative update in a tentative update journal for a first replica of the first data block, subsequent to logging the tentative update, forwarding the write transaction to a second node, determining that the first node restarted before the write transaction was committed on the first node, and rolling back the write transaction for the first replica.
2. The one or more non-transitory computer-readable media of clause 1, wherein the method further comprises subsequent to rolling back the write transaction for the first replica, receiving a read transaction, and returning, by the first node or the second node, data stored in the first data block prior to receiving the write transaction.
3. The one or more non-transitory computer-readable media of clauses 1 or 2, wherein the method further comprises receiving, at the second node, the write transaction from the first node, determining that the second node failed prior to updating a second replica of the first data block, and rolling forward the update for the second replica.
4. The one or more non-transitory computer-readable media of any of clauses 1-3, wherein the method further comprises subsequent to committing the write transaction for the first replica, receiving a read transaction, and returning, by the first node or the second node, data stored in the first data block subsequent to the tentative update.
5. The one or more non-transitory computer-readable media of any of clauses 1-4, wherein the method further comprises subsequent to committing the write transaction, acknowledging, by the first node, completion of the update of the first replica to a storage client.
6. The one or more non-transitory computer-readable media of any of clauses 1-5, wherein the method further comprises in response to receiving the instruction for committing the write transaction, committing, by the second node, the second replica.
7. The one or more non-transitory computer-readable media of any of clauses 1-6, wherein data for the tentative update for the first replica is stored separately from current data for the first replica.
8. The one or more non-transitory computer-readable media of any of clauses 1-7, further comprising recovering, at the first node, from a failure of the first node, determining, at the first node, that a tentative update corresponding to the write transaction is present in the tentative update journal, and rolling back, at the first node, the write transaction for the first replica in response do determining that the tentative update is present.
9. The one or more non-transitory computer-readable media of any of clauses 1-8, further comprising subsequent to rolling back the write transaction, receiving a read transaction, and in response to the read transaction, returning data for the first replica stored prior to the write transaction.
10. The one or more non-transitory computer-readable media of any of clauses 1-9, wherein committing the write transaction on the first node further comprises removing the tentative update from the tentative update journal.
11. In some embodiments, a computer-implemented method comprises receiving, at a first node, a write transaction directed to a first data block of a first extent in an extent group, logging, at the first node, a tentative update in a tentative update journal for a first replica of the first data block, subsequent to logging the tentative update, forwarding the write transaction to a second node, determining that the first node restarted before the write transaction was committed on the first node, and rolling back the write transaction for the first replica.
12. The computer-implemented method of clause 11, further comprising subsequent to rolling back the write transaction for the first replica, receiving a read transaction, and returning, by the first node or the second node, data stored in the first data block prior to receiving the write transaction.
13. The computer-implemented method of clauses 11 or 12, further comprising receiving, at the second node, the write transaction from the first node, determining that the second node failed prior to updating a second replica of the first data block, and rolling forward the update for the second replica.
14. The computer-implemented method of any of clauses 11-13, further comprising subsequent to committing the write transaction for the first replica, receiving a read transaction, and returning, by the first node or the second node, data stored in the first data block subsequent to the tentative update.
15. The computer-implemented method of any of clauses 11-14, further comprising subsequent to committing the write transaction, acknowledging, by the first node, completion of the update of the first replica to a storage client.
16. The computer-implemented method of any of clauses 11-15, further comprising in response to receiving the instruction for committing the write transaction, committing, by the second node, the second replica.
17. The computer-implemented method of any of clauses 11-16, wherein data for the tentative update for the first replica is stored separately from current data for the first replica.
18. The computer-implemented method of any of clauses 11-17, further comprising recovering, at the first node, from a failure of the first node, determining, at the first node, that a tentative update corresponding to the write transaction is present in the tentative update journal, and rolling back, at the first node, the write transaction for the first replica in response do determining that the tentative update is present.
19. The computer-implemented method of any of clauses 11-18, further comprising subsequent to rolling back the write transaction, receiving a read transaction, and in response to the read transaction, returning data for the first replica stored prior to the write transaction.

20. The computer-implemented method of any of clauses 11-19, wherein committing the write transaction on the first node further comprises removing the tentative update from the tentative update journal.
21. In some embodiments, a first computing device comprises memory storing instructions, and one or more processors coupled to the memory and, when executing the instructions, are configured to perform operations comprising receiving, at a first node, a write transaction directed to a first data block of a first extent in an extent group, logging, at the first node, a tentative update in a tentative update journal for a first replica of the first data block, subsequent to logging the tentative update, forwarding the write transaction to a second node, determining that the first node restarted before the write transaction was committed on the first node, and rolling back the write transaction for the first replica.
22. The first computing device of clause 21, wherein the operations further comprise subsequent to rolling back the write transaction for the first replica, receiving a read transaction, and returning, by the first node or the second node, data stored in the first data block prior to receiving the write transaction.
23. The first computing device of clauses 21 or 22, wherein the operations further comprise receiving, at the second node, the write transaction from the first node, determining that the second node failed prior to updating a second replica of the first data block, and rolling forward the update for the second replica.
24. The first computing device of any of clauses 21-23, wherein the operations comprise subsequent to committing the write transaction for the first replica, receiving a read transaction, and returning, by the first node or the second node, data stored in the first data block subsequent to the tentative update.
25. The first computing device of any of clauses 21-24, wherein the operations further comprise subsequent to committing the write transaction, acknowledging, by the first node, completion of the update of the first replica to a storage client.
26. The first computing device of any of clauses 21-25, wherein the operations further comprise in response to receiving the instruction for committing the write transaction, committing, by the second node, the second replica.
27. The first computing device of any of clauses 21-26, wherein data for the tentative update for the first replica is stored separately from current data for the first replica.
26. The first computing device of any of clauses 21-27, wherein the operations further comprise recovering, at the first node, from a failure of the first node, determining, at the first node, that a tentative update corresponding to the write transaction is present in the tentative update journal, and rolling back, at the first node, the write transaction for the first replica in response do determining that the tentative update is present.
29. The first computing device of any of clauses 21-28, wherein the operations further comprise subsequent to rolling back the write transaction, receiving a read transaction, and in response to the read transaction, returning data for the first replica stored prior to the write transaction.
30. The first computing device of any of clauses 21-29, wherein committing the write transaction on the first node further comprises removing the tentative update from the tentative update journal.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing program instructions that, when executed by one or more processors of a first cluster, cause the one or more processors to perform a method comprising:
receiving, at a first node, a write transaction directed to a first data block of a first extent in an extent group;
logging, at the first node, a tentative update in a tentative update journal for a first replica of the first data block;
subsequent to logging the tentative update, forwarding the write transaction to a second node;
determining that the first node restarted before the write transaction was committed on the first node; and
rolling back the write transaction for the first replica.

2. The one or more non-transitory computer-readable media of claim 1, wherein the method further comprises:
subsequent to rolling back the write transaction for the first replica, receiving a read transaction; and
returning, by the first node or the second node, data stored in the first data block prior to receiving the write transaction.

3. The one or more non-transitory computer-readable media of claim 1, wherein the method further comprises:
receiving, at the second node, the write transaction from the first node;
determining that the second node failed prior to updating a second replica of the first data block; and
rolling forward the update for the second replica.

4. The one or more non-transitory computer-readable media of claim 1, wherein the method further comprises:
subsequent to committing the write transaction for the first replica, receiving a read transaction; and
returning, by the first node or the second node, data stored in the first data block subsequent to the tentative update.

5. The one or more non-transitory computer-readable media of claim 4, wherein the method further comprises:
subsequent to committing the write transaction, acknowledging, by the first node, completion of the update of the first replica to a storage client.

6. The one or more non-transitory computer-readable media of claim 1, wherein the method further comprises in response to receiving the instruction for committing the write transaction, committing, by the second node, the second replica.

7. The one or more non-transitory computer-readable media of claim 1, wherein data for the tentative update for the first replica is stored separately from current data for the first replica.

8. The one or more non-transitory computer-readable media of claim 1, further comprising:
recovering, at the first node, from a failure of the first node;
determining, at the first node, that a tentative update corresponding to the write transaction is present in the tentative update journal; and
rolling back, at the first node, the write transaction for the first replica in response do determining that the tentative update is present.

9. The one or more non-transitory computer-readable media of claim 8, further comprising:
subsequent to rolling back the write transaction, receiving a read transaction; and in response to the read transaction, returning data for the first replica stored prior to the write transaction.

10. The one or more non-transitory computer-readable media of claim 1, wherein committing the write transaction on the first node further comprises removing the tentative update from the tentative update journal.

11. A computer-implemented method, comprising:
receiving, at a first node, a write transaction directed to a first data block of a first extent in an extent group;
logging, at the first node, a tentative update in a tentative update journal for a first replica of the first data block;
subsequent to logging the tentative update, forwarding the write transaction to a second node;
determining that the first node restarted before the write transaction was committed on the first node; and
rolling back the write transaction for the first replica.

12. The computer-implemented method of claim 11, further comprising:
subsequent to rolling back the write transaction for the first replica, receiving a read transaction; and
returning, by the first node or the second node, data stored in the first data block prior to receiving the write transaction.

13. The computer-implemented method of claim 11, further comprising:
receiving, at the second node, the write transaction from the first node;
determining that the second node failed prior to updating a second replica of the first data block; and
rolling forward the update for the second replica.

14. The computer-implemented method of claim 11, further comprising:
subsequent to committing the write transaction for the first replica, receiving a read transaction; and
returning, by the first node or the second node, data stored in the first data block subsequent to the tentative update.

15. The computer-implemented method of claim 14, further comprising:
subsequent to committing the write transaction, acknowledging, by the first node, completion of the update of the first replica to a storage client.

16. The computer-implemented method of claim 11, further comprising in response to receiving the instruction for committing the write transaction, committing, by the second node, the second replica.

17. The computer-implemented method of claim 11, wherein data for the tentative update for the first replica is stored separately from current data for the first replica.

18. The computer-implemented method of claim 11, further comprising:
recovering, at the first node, from a failure of the first node;
determining, at the first node, that a tentative update corresponding to the write transaction is present in the tentative update journal; and
rolling back, at the first node, the write transaction for the first replica in response do determining that the tentative update is present.

19. The computer-implemented method of claim 18, further comprising:
subsequent to rolling back the write transaction, receiving a read transaction; and in response to the read transaction, returning data for the first replica stored prior to the write transaction.

20. The computer-implemented method of claim 11, wherein committing the write transaction on the first node further comprises removing the tentative update from the tentative update journal.

21. A first computing device comprising:
memory storing instructions; and
one or more processors coupled to the memory and, when executing the instructions, are configured to perform operations comprising:
receiving, at a first node, a write transaction directed to a first data block of a first extent in an extent group;
logging, at the first node, a tentative update in a tentative update journal for a first replica of the first data block;
subsequent to logging the tentative update, forwarding the write transaction to a second node;
determining that the first node restarted before the write transaction was committed on the first node; and
rolling back the write transaction for the first replica.

22. The first computing device of claim 21, wherein the operations further comprise:
subsequent to rolling back the write transaction for the first replica, receiving a read transaction; and
returning, by the first node or the second node, data stored in the first data block prior to receiving the write transaction.

23. The first computing device of claim 21, wherein the operations further comprise:
receiving, at the second node, the write transaction from the first node;
determining that the second node failed prior to updating a second replica of the first data block; and
rolling forward the update for the second replica.

24. The first computing device of claim 21, wherein the operations comprise:
subsequent to committing the write transaction for the first replica, receiving a read transaction; and
returning, by the first node or the second node, data stored in the first data block subsequent to the tentative update.

25. The first computing device of claim 24, wherein the operations further comprise:
subsequent to committing the write transaction, acknowledging, by the first node, completion of the update of the first replica to a storage client.

26. The first computing device of claim 21, wherein the operations further comprise in response to receiving the instruction for committing the write transaction, committing, by the second node, the second replica.

27. The first computing device of claim 21, wherein data for the tentative update for the first replica is stored separately from current data for the first replica.

28. The first computing device of claim 21, wherein the operations further comprise:
recovering, at the first node, from a failure of the first node;
determining, at the first node, that a tentative update corresponding to the write transaction is present in the tentative update journal; and
rolling back, at the first node, the write transaction for the first replica in response do determining that the tentative update is present.

29. The first computing device of claim 28, wherein the operations further comprise:
subsequent to rolling back the write transaction, receiving a read transaction; and in response to the read transaction, returning data for the first replica stored prior to the write transaction.

30. The first computing device of claim 21, wherein committing the write transaction on the first node further comprises removing the tentative update from the tentative update journal.
